(19) United States
(12) Patent Application Publication
(10) Pub. No.: US 2008/0308331 A1
(43) Pub. Date: Dec. 18, 2008

(54) Motorcycle including a rider saddle and a fuel tank

(75) Inventors: Johann Trunkenpolz, Maria Schmolln (AT); Bernhard Plazotta, Oberndorf (AT); Helmut Grobner, Petting (DE)

Correspondence Address: LAW OFFICE OF ROD D. BAKER, 707 STATE HIGHWAY 333, SUITE B, TIJERAS, NM, 87059-7382, US

(73) Assignee: KTM Sportmotorcycle AG, Mattighofen (AT)

(21) Appl. No.: 12/154,501

(22) Filed: May 23, 2008

(30) Foreign Application Priority Data
May 23, 2007 (DE) 10 2007 023 962.0

(51) Int. Cl. B60K 13/02

(52) U.S. Cl. 180/68.3

(57) ABSTRACT

There is disclosed a motorcycle including a rider saddle (16) and a fuel tank (18), as well as an air intake apparatus (29) provided with a filter element (25) for filtering intake air for an internal combustion engine of the motorcycle (1). The air intake apparatus (29) has a filter element mount (24) and the filter element mount (24) is formed integrally with a portion of the fuel tank (18). The fuel tank functions are thus economically integrated with the functions of the air intake apparatus.

### CROSS-REFERENCE TO RELATED APPLICATIONS

This application claims priority to German Patent Application No. DE 10 2007 023 962.0, filed on May 23, 2007, the entirety of which is incorporated herein by refernece.

### BACKGROUND OF THE INVENTION

1. Field of the Invention

The present invention relates to a motorcycle having a rider saddle and a fuel tank, and more particularly to an air intake apparatus provided with a filter element for filtering intake air for an internal combustion engine of the motorcycle; the air intake apparatus has a filter element mount. The invention also relates to a fuel tank for a motorcycle, the fuel tank featuring an integrated air intake apparatus.

2. Background Art

A motorcycle powered by an internal combustion engine usually comprises an air intake apparatus (air box) in which a filter element (air cleaner) is arranged for filtering out debris entrained in the intake air of the engine. In addition, the air intake apparatus has the function of muffling engine snorting.

For this purpose, known air intake apparatuses comprise a housing comprising a cavity for fluidly communicating air from the environment, and through which the air can enter the housing of the air intake apparatus. In addition, the housing comprises a number of ports, corresponding to the number of cylinders of the engine, for porting cleaned intake air in the direction of the engine. The filter element provided in the air intake apparatus divides the space configured in the housing into an unclean air portion with unfiltered intake air and a clean air portion with already filtered intake air.

The housing of most known air intake devies usually is engineered segmented: one segment comprising the filter element, and a cover (for closing off the segment) configured with an opening for porting unclean intake air into the housing of the air intake apparatus. The clean air portion is connected by a fluid communication conduit, in the form of an intake cavity or the like, to a carburation device in the form of a throttle valve body or carburetor of the engine. In other words, with such a configuration the housing of the air intake device is constituted of many different separate components. Such air intake devices then need to be atatched to the frame of the motorcycle, taking up space, on the one hand, and on the other, requiring an extension arm or the like on the frame for releasably connecting it thereto.

In addition to the air intake apparatus, the motorcycle also has a fuel tank provided for mounting on the frame of the motorcycle and engineered as a separate component, connected by fixation points to the frame.

Known from JP 06312680 A is an air intake apparatus for a motorcycle, for example, having an air chamber in the rear portion of a fuel tank and arranged ahead of a rider saddle—in other words, between the rider saddle and the fuel tank. This air chamber is closed off by a cover arranged between the fuel tank and the rider saddle, so that the fuel tank comprises an air intake apparatus having a separate housing arranged between the fuel tank and the rider saddle.

Known from JP 61155024 A is an air intake apparatus for a motorcycle, having within the fuel tank an air intake apparatus featuring a separate housing, from which the cleaned intake air is fluidly communicated in the direction of the engine of the motorcycle. A cavity configured to receive the housing in the interior of the fuel tank takes up space in the fuel tank, thus reducing tank capacity.

Known in turn from JP 60261732 A is a configuration similar to that of the air intake devices as aforementioned, provided with an air intake device in the region between the fuel tank and the rider saddle, such that the air intake apparatus is located ahead of the rider saddle, arranged on top of the fuel tank.

Known from JP 11099977 A is a motorcycle featuring an air intake apparatus having a separate housing, the air intake device being arranged within the fuel tank in a cavity, again significantly reducing the tank capacity of the tank.

Known from EP 0602591 A1 is an air cleaner for a motorcycle, the air intake device again having a separate housing about the cleaner element.

Known from U.S. Pat. No. 4,648,474 is an air cleaner system for motorcycles which makes use of a cavity formed in a main frame component, and which has an opening in a fuel tank of the motorcycle permitting access to the air cleaner assembly.

Common to each air intake device listed above is that irrespective of whether the air intake apparatus is secured to the frame of the motorcycle or to the periphery of the fuel tank or within a cavity of the fuel tank, the fuel tank and the air intake apparatus are engineered as separate units and thus can either not be defined on the motorcycle space-savingly, due to separate fixation points being needed, or because of the cavity in the fuel tank for the separate air intake apparatus the tank capacity is significantly reduced. Moreover, separately engineering the air intake apparatus and the fuel tank takes up space, limiting the space needed for mounting other components on the motorcycle. Providing the air intake device seperately from the tank also means that during motorcycle assembly separate assemblies need to be fitted, correspondingly adding to the complexity in scheduling material as needed for production of the motorcycle. The entire disclosures of the above-referneced patent publications are incorporated herein by reference.

The present invention is thus based on the object of providing a motorcycle including a fuel tank which eliminates the cited disadvantages. Also provided is a corresponding fuel tank for the motorcycle.

### SUMMARY OF THE INVENTION

There is disclosed a motorcycle including a rider saddle and a fuel tank, as well as an air intake apparatus provided with a filter element for filtering intake air for an internal combustion engine of the motorcycle. The air intake apparatus has a filter element mount, the filter element mount being configured by a portion formed by the fuel tank. In this arrangement, the filter mounting portion is the portion at which the filter element is located. In the apapratus according to this disclosure, the filter element mount has a portion that is engineered as a portion of the fuel tank. It thus is achieved that the air intake apparatus no longer requires its own housing. This beneficially eliminates the need to mount an air intake apparatus having its own housing—thus saving the space taken up by the housing of the air intake apparatus, and allowing for a higher capacity of the fuel tank, for example.

Further, by arranging the fuel tank comprising the filter element mount on the frame of the motorcycle, the assembly time in production of the motorcycle is reduced, in comparison with the former requirement for mounting the separate air intake apparatus on the motorcycle. This also simplifies scheduling material as needed for production of the motorcycle, since there is no need for a separate air intake apparatus assembly.

In addition to this, the presently disclosed apparatus also makes for the advantage of added freedom in design of the space surrounding the motorcycle frame, since the space formerly required for the air intake apparatus is now available for other components. This also creates a space-saving arrangement of fuel tank and air intake apparatus, so that the fuel tank can now be engineered smaller and slimmer than known configurations of comparable capacity. This is because of now arranging the air intake apparatus within the fuel tank as is not the case with known configurations the space needed to accommodate the housing of the air intake apparatus is now eliminated by the configuration in accordance with the present disclosure. This now makes it possible to style the fuel tank slimmer and snugly located on the mainframe of the motorcycle so that the rider has added freedom of movement on the motorcycle by the elimination of a bulky fuel tank.

The present apparatus achieves furthermore that separate fixation points for attaching the air intake apparatus to the motorcycle frame are eliminated. Thus, for example, there is now no need for an auxiliary frame or extension arm on the frame, as formerly required to mount the air intake apparatus, thus simplifying the overall design of the frame. Lastly, integrating the filter element mount within the fuel tank also results in a reduction in the number of components needed to make the motorcycle. This is because the function of the air intake apparatus and that of the fuel tank are now combined into a multifunction assembly. And the configuration according to the present apparatus, as compared to the known configuration where the fuel tank and air intake are separate, now make it possible to integrate the two functions to eliminate separate housing components of the air intake apparatus. This reduces the weight of the assembly formed by the fuel tank and filter element mount, as compared to these components being provided separately.

The disclosed apparatus thus provides for the filter element mount being configured to have a portion thereof that also is formed of a portion the fuel tank. This enables the location of a filter element mount in the fuel tank. The filter element may be disposed in a first cavity of the tank which, as compared to known configurations, saves space for arranging a housing of the air intake apparatus. This is because a separate housing is now no longer needed for the air intake apparatus in accordance with the present disclosure.

In one aspect of the present apparatus it is, however, also provided for that the filter element mount is engineered in one piece with the fuel tank. When making the fuel tank of, for example, a plastics material, the filter element mounting portion can be moulded integrally with the fuel tank by rotational, die-cast or injection moulding. Due to the self-supporting configuration of the fuel tank, there is no longer any need for an auxiliary frame arrangement or separate fixation points for attaching the air intake apparatus to the motorcycle frame.

In another aspect of the present apparatus it is provided for that the air intake apparatus is an integral component of the fuel tank, and at least one unclean air portion and/or clean air portion of the air intake apparatus is included by wall portions formed by the fuel tank. This achieves that wall portions, forming the fuel tank, now simultaneously form an unclean air portion and/or a clean air portion of the air intake apparatus -thus achieving a functional integration and doing away with separate housing components for forming the air intake apparatus.

In the known configurations as described previously hereinabove, the air intake apparatus is arranged between the fuel tank and the rider saddle, thus restricting the freedom of movement of the rider on the rider saddle in the direction of the handlebars.

The present apparatus also solves this problem in that it being provided that the air intake apparatus is arranged beneath the rider saddle, and at least partial portions of an unclean air portion of the air intake apparatus are defined by the rider saddle. This achieves, as compared to the known configurations as described above, added freedom of movement of the rider. There also is realized the the advantage that the rider saddle can also handle the function of porting intake air into the unclean air portion of the air intake apparatus. For this purpose, it is provided in accordance with the present apparatus that a base arranged at the rider saddle defines in part a first cavity configured in the fuel tank, in which the filter element is arranged.

The rider saddle may thus comprise a base or a sub-structure partially covering or defining a cavity configured in the fuel tank, in which first cavity is mounted the filter element. This results in the sub-structure of the rider saddle now functioning as a cover for the air intake apparatus, doing away with a separate component for this purpose. The sub-structure of the rider saddle can now be engineered to double as a component for fluid communication of unclean air.

In accordance with yet another aspect of the present apparatus, the fuel tank has an elongated configuration, and a first cavity of the fuel tank is configured to mount the filter element. The lateral or side portions of the elongated tank, which receive and hold fuel, are on both respective sides of the cavity containing the air filter element. This configuration advantageously muffles engine snorting through the apparatus portion containing the filter element, by the first cavity being surrounded by the side portions of the fuel tank.

The motorcycle provided for in accordance with this disclosure may be, for example, designed for off-road competition, posing the additional problem of the air intake in the unclean air portion of the air intake apparatus entraining dust, sand, water or other debris. To reduce the debris entrained in the intake air in the unclean air portion, it is provided that the rider saddle covers the fuel tank (at least in part) lengthwise and between a base of the rider saddle and a top side of the fuel tank, to define a duct configured for fluidly communicating intake air in the direction of the engine. This makes possible air porting between the sub-structure of the rider saddle and the top of the fuel tank, insuring that the unclean air portion is located as high as possible within the outer dimensions of the motorcycle. Higher location of air intake reduces the amount of debris entrained in the unfiltered intake air in the unclean air portion of the air intake apapratus.

As it reads from above, the tank walls forming the fuel tank can also form at least parts of the clean air portion of the air intake apparatus. A further simplified design is now achievable in production in that, insertable in a cavity configured in the fuel tank, is a preferably flexibly configured member. This flexible member forms, downstream of the filter element, a clean air portion. It is engineered to fluidly communicate intake air in the direction of the engine.

The flexible member may be premoulded, for example prefabricated from a flexible elastomer suitable for injection moulding. When the present apparatus is fully assembled, the flexible member is sealably inserted in the cavity configured in the fuel tank. The flexible member has edge portions which sealably engage the edge of the fuel tank defining the opening into of the cavity therein. The flecible member thus forms, or expands, a clean air portion downstream of the filter element whilst simultaneously fluidly communicating the cleaned intake air in the direction of the engine. This is why an appendage fluidly communicating cleaned intake air from the clean air portion in the direction of a throttle valve body or carburettor may be configured at the premoulded member.

The filter element concerned may be a wet-type air cleaner in the form of a foamed plastic element releasably attachable to a filter element support. The present apparatus thus also provides, generally adjacent or proximate to the filter element mount, a filter element support to which the filter element is attachable.

In addition to locating the intake air portion beneath the rider saddle as discussed above, it is also provided in an optional aspect that the fuel tank is provided, in the region proximate the first cavity containing the filter element, with at least one further cavity, via which intake air is fluidly communicated in the direction of an unclean air portion of the air intake apparatus. This makes it possible to also fluidly communicate intake air from air impinging the fuel tank when the motorcycle is on the move, via this further or second cavity in the region of the unclean air portion of the air intake apparatus.

In accordance with yet another aspect of the present present apparatus, it is provided that, in the longitudinal direction of the motorcycle, the fuel tank extends from a portion or point proximate to a handlebar header pipe back to a point above a fulcrum of a rear fork of the motorcycle. This achieves that a large tank capacity is available. Also, the filter element arranged in the cavity of the fuel tank is surrounded by a corresponding large volume of fuel (or at a minimum by a portion of the fuel tank for receiving fuel), thus muffling undesirable “snorting.”

Should a further increase in the tank capacity be desired, it is also provided in yet another aspect of the present apparatus that, in the longitudinal direction of the motorcycle, the fuel tank extends from a point or portion proximate to a handlebar header pipe to a point above a rear wheel of the motorcycle. This allows a configuration which has (in motorcycle terminology) arranged fore and aft of the vertical center of gravity axis, a front tank and a rear tank respectively, but in the present apparatus the fuel tank integrates the function of the air intake apparatus. In other words, a fuel tank configured according to the present disclosure optionally has both the function of a front tank and the function of a rear tank, with the additional function of an air intake apparatus, and can be made in one piece of plastics material moulded for example by rotational, die-cast or injection moulding. Additionally, this configuration has the advantage that it is engineered to be self-supporting, in no longer requiring an auxiliary frame since it can be mounted on the frame of the motorcycle and simultaneously put to use as a support for the rider saddle and for electronic and/or electrical components or assemblies. Indeed, even a preassembled wiring harness for the electrical system of the motorcycle can be attached on the fuel tank thus configured. This configuration also offers the further advantage that after removal of the fuel tank, all function assemblies of the motorcycle such as, for example, spring strut, carburetor, or engine located underneath are freely accessible for servicing or maintenance—thus drastically speeding up the time involved in maintenance and servicing a motorcycle configured as such.

In addition to the foregoing, configuring the fuel tank as a front tank and simultaneously as a rear tank achieves a distribution of wheel loading and thus a balanced distribution of the weight as wanted in conjunction with an unbiased handling response of the motorcycle.

In accordance with yet another aspect of the present apparatus, arranged in the region of a lowest point of the fuel tank is a fuel pump, so that the increase in fuel tank capacity also achieved by the configuration in accordance with this disclosure also makes for added mileage per tank fill which is, for example, of major importance in competition bikes.

In accordance with still another aspect of the present apparatus, it also is provided that at or in and end portion (in the longitudinal direction of the motorcycle) of the fuel tank, opposite the handlebar header pipe, a vent valve is arranged. The vent valve is provided so that to save time the fuel tank can be fuelled, for example, by means of a fast-fuelling system. In one modification of such a fuel tank, it is also possible that air in the fuel tank forced out by the inflow of fuel is ported back via the vent valve, for example, by fluid communication into the region of a filler provided on the fuel tank. This prevents the escape of fuel vapour during fuelling by the vapour being absorbed by the fast-fuelling system.

A further function integrated in the fuel tank of the motorcycle in accordance with the present apparatus is now achievable in that a lower portion of the fuel tank facing a rear wheel of the motorcycle is configured curved as a mudguard for the rear wheel. This eliminates having to fit an additional mudguard to the motorcycle in accordance with the invention.

In yet another modification in accordance with the present disclosure it is provided that a front lower portion of the fuel tank (in the longitudinal direction of the motorcycle) is configured ported for fluidly communicating intake air in the direction of an unclean air portion of the air intake apparatus. This achieves a longer passage of the intake air through the porting of the fuel tank, helping to further muffle engine air intake snorting of the motorcycle.

In addition to muffling snorting in the unclean air portion, it is also provided in the present apparatus that, at a clean air portion of the air intake apparatus, a housing is releasably attached which increases the clean air portion of the air intake. This increase in the clean air portion makes for added muffling of air intake snorting of the engine, as a result of which the motorcycle configured as such is quieter in all as is of importance, for example, on motorcycles in trial events.

The motorcycle can in accordance with the present disclosure comprise a fuel tank engineered self-supporting and atatchable to the motorcycle frame by means of a fixed mount and at least one releasable mount at a frame of the motorcycle, for instance by the fuel tank being atatched nearby the handlebar header pipe by means of a pivot mount.

The fuel tank thus is hingeable mounted to pivot about the pivot mount, to be swingable up and dwon in the direction of a yaw axis of the motorcycle. Such pivotal movement facilitates free access to components in the motorcycle (for example, a spring damper element or shock strut) after having removed the rider saddle and hingeably pivoting upward the fuel tank as needed, for example, in making adjustments or installing components.

Due to the fuel tank being optionally being configured as both a front tank and a rear tank, the motorcycle engineered as such has a large tank capacity. So that the distribution of the wheel load of the motorcycle engineered as such is not affected by fuel sloshing in the fuel tank. The fuel tank, at its portion surrounding the cavity containing the filter element, has at least one constriction such that the flow rate of the fuel between the front and rear portion of the fuel tank (in the fore/aft or longitudinal direction of the motorcycle) is reduced in the region of the constriction. This constriction acts like a restriction in ensuring that any pulsations prompted in the direction of the fore/aft direction or yaw direction of the motorcycle by, for example, bumpy travel or sudden acceleration and braking action of the motorcycle, do not result in changes in the distribution of the wheel loading or in the handling response.

The fuel tank of the motorcycle in accordance with the present disclosure may be made of a plastics material, particularly polyethylene and/or polyamide. Using polyethylene, for example, may occur in series production of the motorcycle in accordance with this disclosure because although polyethylene tends to expand more than, for instance, polyamide, in contact with fuel it contributes towards cost-effective production. Using polyamide may occur, for example, in motorcycles intended for competition events, because polyamide expands less than polyethylene in contact with fuel, and additionally reduces fuel diffusion. In accordance with another aspect of the present apparatus it is also provided for that that the fuel tank is configured double-shelled with an inner shell of polyamide and an outer shell of polyethylene so that elongation of the fuel tank in contact with the fuel is reduced by the inner shell of polyamide whilst the outer shell of polyethylene excludes damage of the polyamide shell by debris and stones thrown up by the wheels.

The motorcycle in accordance with this disclosure now makes it possible by its fuel tank being engineered in one piece as a combination front tank and rear tank to significantly increase the tank capacity since the fuel tank can now be engineered adapted to the frame structure of the motorcycle. When such a motorcycle is put to use in off-road competition events there is a need to ensure that a good suspension is available, achievable for example by a flow return at the spring/damper unit. For this purpose it is provided for in another aspect of the present apparatus that at its underside the fuel tank is provided with an exterior concavity to accommodate for the mounting of a spring/damper unit of the motorcycle (which can also mount the aforementioned flow return).

This disclosure accordingly teaches for a fuel tank for a motorcycle including an air intake apparatus and a filter element mount for a filter element for filtering intake air for an internal combustion engine of the motorcycle, the filter element mount being configured at a portion formed by the fuel tank and the filter element is definably mounted at the filter element mount such that the filter element separates an unclean air portion and a clean air portion. The fuel tank can thus be configured, for example, in one piece with the filter element mount at which the filter element can be atatched, for example, via a spring clip or the like. In this arrangement, the fuel tank forms at least partial portions of a clean air portion and/or of an unclean air portion, the clean air portion being formed by side walls configured in one piece with the fuel tank and comprising an outlet for fluidly communicating intake air in the direction of the engine.

It is furthermore also provided for that the filter element mount surrounds an opening for passage of intake air and the filter element is sealingly mountable at the opening directly or by means of a filter element support.

### BRIEF DESCRIPTION OF THE DRAWINGS

The accompanying drawings, which are incorporated into and form a part of the specification, are for the purpose of illustrating a preferred embodiment of the apparatus, and are not to be construed as limiting the invention. The present apparatus will now detailed with reference to the drawing in which:

FIG. 1 is partly sectioned side view of a motorcycle in accordance with one aspect of the present disclosure;

FIG. 2 is a magnified view of the fuel tank of the motorcycle as shown in FIG. 1 showing the rider saddle arranged thereon in a section view; and

FIG. 3 is a view similar to that as shown in FIG. 1 showing a motorcycle in accordance with another aspect with a modified fuel tank.

### DESCRIPTION OF THE PREFERRED EMBODIMENTS (BEST MODE FOR PRACTICING THE INVENTION)

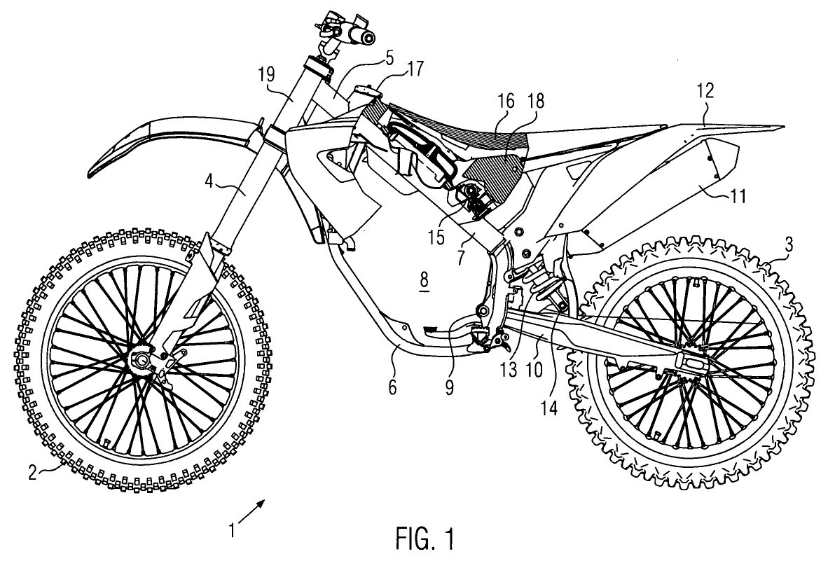

Referring now to FIG. 1 of the drawings, there is illustrated diagrammatically a motorcycle 1 in accordance with the present disclosure. For simplicity of illustration some conventional components (for example, an internal combustion engine and the gearbox connected thereto, as well as a drive chain transmitting the driving power from the engine to the rear wheel) are omitted. In addition, the brake disks on the front wheel 2 and rear wheel 3 of the motorcycle 1 also have been omitted for the sake of clarity.

As shown, the motorcycle 1 comprises a front fork 4 with spring/damper units and a frame 5 configured as a cradle frame with bracings 6. An engine (not shown), for example a four-stroke engine, is accommodated within a mounting space 8 formed by a upper tube 7 and the bracings 6. The frame 5 comprises a lower delta portion 9 at which a rear fork 10 is mounted for guiding the rear wheel 3.

A muffler 11 of the exhaust system is shown beneath a mudguard 12 covering the rear wheel 3 which, in a top-down view, is arranged running along the right-hand side of the motorcycle 1. A spring/damper unit 13 comprises a lower fixation point 14 for pivotally mounting the rear fork 10, and a upper fixation point 15 for joining an extension arm of the frame 5. The spring/damper unit 13 may also have at the lower fixation point 14 or upper fixation point 15 a flow return with which the available spring travel can be lengthened.

A rider saddle 16 configured as a seat assembly extends in the fore/aft direction of the motorcycle from one portion adjoining a filler 17 of a fuel tank 18 to a rear portion adjoining the mudguard 12 (as viewed from a portion adjoining a handlebar header pipe 19 from the front toward the rear).

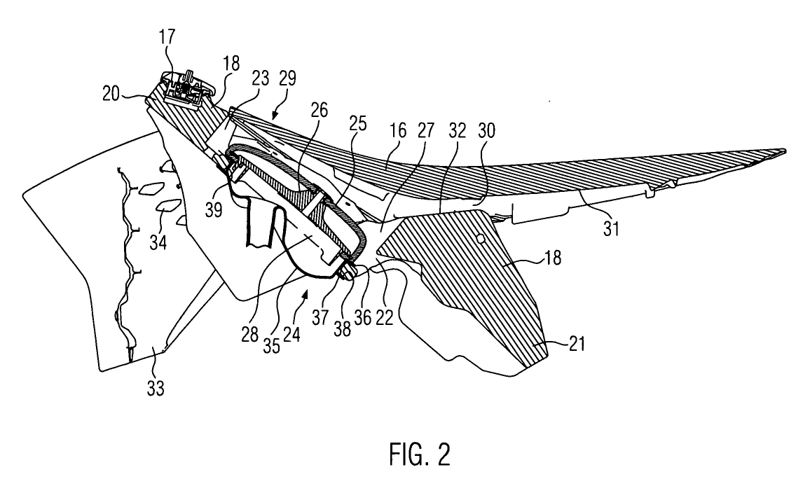

Referring now to FIG. 2, there is illustrated the fuel tank 18 of the motorcycle 1 on a magnified scale to assist in the following further explanations. Overall, the fuel tank 18 preferably has an elongated configuration, including a filler 17 through which the fuel is introduced into the fuel tank 18. In this arrangement the fuel tank 18 can accommodate the fuel in the front or upper tank portion 20, the rear or lower tank portion 21, and a connecting portion 22 connecting the upper tank portion 20 to the lower tank portion 21. These tank portions 20, 21, and 22 at least partially surround a first cavity 23 defined by and in the fuel tank 18. In the cavity 23 a filter element mount 24 is provided for mounting a filter element 25 which, in the aspect as shown, is formed by a foamed plastic element sited on a filter element support 26.

In the aspect as shown in FIG. 1 and FIG. 2, respectively, the filter element 25 is arranged on the filter element support 26 which, together with the filter element 25, is releasably definable at the filter element mount 24 for example by means of a spring clip (not shown). In this arrangement the filter element 25 separates, or more accuratly divides, an unclean air portion 27 formed in the cavity 23 from a clean air portion 28 of the air intake apparatus 29.

The intake air required for combustion inside the engine preferably accesses the unclean air portion 27 of the air intake apparatus through a duct 30 formed and defined by and between a base 31 of the rider saddle 16 and a top side 32 of the fuel tank.

Referring again to FIG. 1, there is illustrated how the duct 30 is protected by the mudguard 12 from debris thrown up by the rear wheel 3. A partial flow of the intake air in this aspect as shown can also gain access to the unclean air portion 27 formed in the cavity 23 from the air impinging the fuel tank 18 when the motorcycle 1 is on the move.

To guide the air in the front portion of the fuel tank 18, there is provided on both sides of the fore/aft or longitudinal centerline of the motorcycle 1 a fairing 33 with ports 34 through which intake air can flow from the environment between the fairing 33 and the fuel tank 18; on both sides of the cavity 23 a second cavity is provided via which the flow of intake air can enter and thus gain access to the unclean air portion 27 of the air intake apparatus.

After the unfiltered intake air has passed through the filter element 25, the intake air gains access to the clean air portion 28. Referring particularly to FIG. 2, a flexible member 35 is shown arranged partly within the cavity 23 and extending in the direction of the mounting space 8 for the engine. The flexible member 35 is sealingly fitted in the cavity 23 of the fuel tank 18; each of upper and lower sealing edges 36, 37 of the flexible member 35 engages the edges of the tank portions 20, 21, 22, which define the (typically circular or oval) opening 39 into cavity 23 for passage of filtered intake air in the direction of the engine. In addition, the flexible member 35 has the advantage that by insertably arranging it within the opening 39, no debris can move past the edge 38 of the opening 39, thus enclosing completely the clean air portion 28 without further housing components.

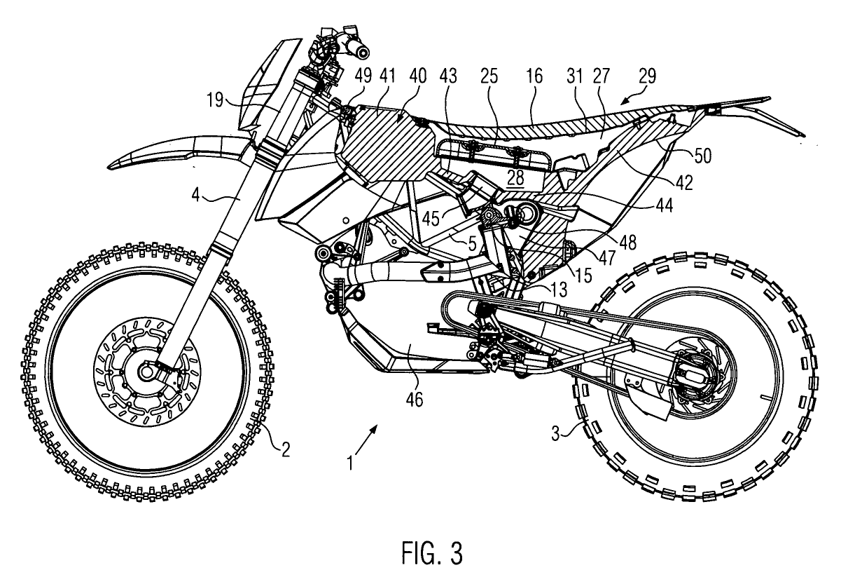

Referring now to FIG. 3, there is illustrated in a partly sectioned view a motorcycle 1 in accordance with an alternative embodiment of an apparatus in accordance with this disclosure. The mototorcycle sports a fuel tank 40 modified as compared to the fuel tank 18 as shown in FIGS. 1 and 2. The fuel tank 40 in accordance with this alternative embdoiment has a larger capacity than the fuel tank 18 as shown in FIGS. 1 and 2, as is mainly achieved by the fuel tank 40 being configured in one piece (i.e., both as a front tank and as a rear tank).

In the motorcycle 1 as shown in FIG. 3, the vertical axis of the center of gravity of the motorcycle 1 runs roughly through the upper fixation point 15 of the spring/damper unit 13. The fuel tank 40 (as viewed in the forwards travel direction of the motorcycle) is configured ahead or forward of the vertical axis of the center of gravity running through the upper fixation point 15 as a front tank 41 and, (as viewed in forwards travel direction of the motorcycle) aft of the vertical axis of the center of gravity as a rear tank portion 42. The front tank portion 41 and rear tank portion 42 are interconnected by a connecting portion 43 which, on the one hand, is configured for fluidly communicating fuel from the front tank portion 41 into the rear tank portion 42 and, on the other, also forming at the same time by its side walls and its bottom wall 44 the walls of the clean air portion 28 of the fuel tank 40. In this embodiment, the bottom wall 44 has an opening for a passage 45 through which the intake air cleaned in the clean air portion 28 fluidly communicates in the direction of an engine 46 (indicated simply diagrammatically, i.e., in the direction of a carburation device in the form of a throttle valve body or carburettor of the engine 46).

Similar to the embdoiment shown in FIGS. 1 and 2, the unclean air portion 27 is arranged above the filter element 25 and beneath the base 31 of the rider saddle 16, such that side walls of the unclean air portion 27 are formed by walls forming the fuel tank 40, and the base 31 of the rider saddle 16 has the function of a cover for the air intake apparatus 29. In the lowest portion of the fuel tank 18 and 40 respectively as viewed in the yaw axis direction of the motorcycle 1 as shown in FIGS. 1 and 3, an electrically operated fuel pump is disposed. The pump pumps the fuel in the direction of the carburation device of the motorcycle whilst simultaneously pressurizing the fuel for a fuel injector.

As is readily evident from FIG. 3, the fuel tank 40 forms a rear concavity 47 in the region of the rear tank 42. This exterior cavity 47 serves to provide a space to accommodate the arrangement of the spring/damper unit 13 or reservoir or flow return 48 arranged at the upper end of the spring/damper unit 13.

In the region of its front tank portion 41, the fuel tank 40 is attached to the frame 5 by a fixed pivot mount 49, and by two further floating mounting points at the frame so that the fuel tank 40 is able to perform a corresponding lengthwise equalization at the frame 5. The fuel tank 40 can be hingeably pivoted upwards and downwards aroung the pivot mount 49, so that after removal of the rider saddle 16 and pivotally moving the fuel tank 40, the spring/damper unit 13, for example, is freely accessible for setting, servicing or replacing it.

The fuel tank 40 is engineered totally self-supporting, so that no rear frame or rear frame extension arm needs to be secured to the frame 5. The fuel tank 40 also serves to support the weight of the motorcycle rider via the rider saddle 16. In addition, the rear tank portion 42 is configured curved, with a curvature comlementary to the arc of the rear wheel 3 as seen in FIG. 3, in thus forming a mudguard 50 for the rear wheel 3.

It is possible to further modify the fuel tank 40 so that, for example, concavity 47 can be omitted as is possible, for example, including a motorcycle which is to be equipped with less spring travel. When this is the case, the clean air portion 28 can be correspondingly extended by reconfiguring the connecting portion 43 or the bottom wall 44, respectively, so that the clean air portion 28 becomes significantly larger in thus contributing towards diminishing the snort of the engine and making for quieter operation of the motorcycle. In an alternative aspect it is also possible—for instance by a housing (not shown) connected to the clean air portion 28—to achieve a significant increase in the size of the clean air portion 28 (again, for instance, to further muffle engine snorting by making a chamber available).

In this way, that the fuel tank integrates the function of the air intake apparatus (airbox) to facilitate, on the one hand, fitting the airbox to the motorcycle in production thereof by eliminating separate installation thereof whilst, on the other, reducing the number of components needed to manufacture the motorcycle.

It is understood that as regards all features of the invention not explained above in detail reference is expressly made to the claims and the drawing.

List of reference numerals
1 motorcycle
2 front wheel
3 rear wheel
4 front fork
5 frame
6 bracings
7 upper tube
8 mounting space
9 delta portion
10 rear fork
11 muffler
12 mudguard
13 spring/damper unit
14 lower fixation point
15 upper fixation point
16 rider saddle
17 filler
18 fuel tank
19 handlebar header pipe
20 front/upper mounting portion
21 lower/rear mounting portion
22 connecting portion
23 cavity
24 filter element mounting portion
25 filter element
26 filter element support
27 unclean air portion
28 clean air portion
29 air intake apparatus
30 duct
31 base
32 top side of fuel tank
33 fairing
34 opening
35 flexible member
36 upper sealing edge
37 lower sealing edge
38 edge
39 cavity
40 fuel tank
41 front tank
42 rear tank
43 connecting portion
44 bottom wall
45 opening/passage
46 engine
47 cavity
48 flow return
49 pivot mount
50 mudguard

Although the invention has been described in detail with particular reference to these preferred embodiments, other embodiments can achieve the same results. Variations and modifications of the present invention will be obvious to those skilled in the art and it is intended to cover in the appended claims all such modifications and equivalents.

What is claimed is:

1. A motorcycle having a rider saddle, a fuel tank, an air intake apparatus with a filter element for filtering intake air for an internal combustion engine of the motorcycle, wherein the air intake apparatus comprises a filter element mount, and wherein further a portion of the filter element mount is defined by a portion of the fuel tank.

2. The motorcycle as set forth in claim 1 wherein the filter element mount is integrally formed with the fuel tank.

3. The motorcycle as set forth in claim 1 wherein the air intake apparatus comprises:
an integral component of the fuel tank; and
an unclean air portion defined at least in part by wall portions of the fuel tank.

4. The motorcycle as set forth in claim 1 wherein the air intake apparatus comprises:
an integral component of the fuel tank; and
a clean air portion defined at least in part by wall portions of the fuel tank.

5. The motorcycle as set forth in claim 1 wherein the air intake apparatus is arranged beneath the rider saddle, and at least partial portions of an unclean air portion of the air intake apparatus are defined by the rider saddle.

6. The motorcycle as set forth in claim 5 wherein the rider saddle comprises a base, the base defining in the fuel tank a cavity in which the filter element is disposed.

7. The motorcycle as set forth in claim 1 wherein the fuel tank comprises an elongated configuration, and the fuel tank defining a cavity adapted to mount therein the filter element, and wherein further the filter element is enclosed least by side portions of the fuel tank.

8. The motorcycle as set forth in claim 1 wherein:
the rider saddle at least partially covers the fuel tank longitudinally; and
a duct for fluidly communicating intake air is defined at least in part by and between a base of the rider saddle and a top side of the fuel tank.

9. The motorcycle as set forth in claim 1, further comprising a flexibly configured member defining downstream of the filter element a clean air portion of the air intake apparatus, and the flexibly configured member being insertable in a cavity configured in the fuel tank, and being adapted to fluidly communicate intake air in the direction of the engine.

10. The motorcycle as set forth in claim 2, further comprising a filter element support on which the filter element is attachable proximatee to the filter element mount.

11. The motorcycle as set forth in claim 1 wherein the the fuel tank defines:
a first cavity for receiving therein the filter element; and
a second cavity via which intake air is fluidly communicatable in the direction of an unclean air portion of the air intake apparatus.

12. The motorcycle as set forth in claim 7 wherein the fuel tank extends, in the longitudinal direction of the motorcycle, from proximate to a handlebar header pipe to point above a fulcrum of a rear fork of the motorcycle.

13. The motorcycle as set forth in claim 7 wherein the fuel tank extends, in the longitudinal direction of the motorcycle, from proximate to a handlebar header pipe to point above a rear wheel of the motorcycle.

14. The motorcycle as set forth in claim 1, further comprising a fuel pump arranged in lowest point of the fuel tank.

15. The motorcycle as set forth in claim 7, further comprising a vent valve in an end portion of the fuel tank opposite, in the longitudinal direction of the motorcycle, a handlebar header pipe.

16. The motorcycle as set forth in claim 7 wherein a lower portion of the fuel tank, facing a rear wheel of the motorcycle, is configured curved as a mudguard for the rear wheel.

17. The motorcycle as set forth in claim 1 wherein a front lower portion of the fuel tank is ported for fluidly communicating intake air in the direction of an unclean air portion of the air intake apparatus.

18. The motorcycle as set forth in claim 1 wherein the fuel tank is self-supporting, and is attachable to a frame of the motorcycle by a fixed mount and at least one floating mount.

19. The motorcycle as set forth in claim 1 wherein the fuel tank is attached to a frame of the motorcycle by a pivot mount, whereby the fuel tank is hingeably pivotable in the direction of a yaw axis of the motorcycle.

20. The motorcycle as set forth in claim 4, further comprising a housing for increasing the clean air portion of the air intake apparatus, the housing being releasably attachable to the air intake apparatus.

21. The motorcycle as set forth in claim 1 wherein the fuel tank comprises:
a portion surrounding a cavity in which the filter element is arranged; and
at least one constriction proximate the cavity, whereby fuel flow rate in the longitudinal direction of the motorcycle and between front and rear portions of the fuel tank is reduced by the constriction.

22. The motorcycle as set forth in claim 1 wherein the fuel tank comprises polyethylene.

23. The motorcycle as set forth in claim 1 wherein the fuel tank comprises polyamide.

24. The motorcycle as set forth in claim 23 wherein the fuel tank comprises an inner shell of polyamide and an outer shell of polyethylene.

25. The motorcycle as set forth in claim 1 wherein the fuel tank defines an exterior cavity to accommodate a spring or damper unit of the motorcycle.

26. On motorcycle a fuel tank apparatus comprising:
an air intake apparatus defining an unclean air portion and a clean air portion; and
a filter element mount for a filter element for filtering intake air for an internal combustion engine of the motorcycle, the filter element mount comprising a portion formed from a portion of the fuel tank; wherein the filter element is mounted on the filter element mount such that the filter element divides the unclean air portion from the clean air portion.

27. The apparatus set forth in claim 25 wherein the clean air portion is defined by side walls configured in one piece with the fuel tank, and further comprising an outlet for fluidly communicating intake air in the direction of the engine.

28. The apparatus set forth in claim 25 wherein the filter element mount defines an opening for passage of intake air, and the filter element is sealingly mountable at the opening.

29. The apparatus set forth in claim 28 wherein the filter element is sealingly mountable at the opening by means of a filter element support.
